(19) United States
(12) Patent Application Publication
(10) Pub. No.: US 2005/0021652 A1
(43) Pub. Date: Jan. 27, 2005

(54) Synchronous collaborative shell integrated instant messaging

(75) Inventor: Margaret McCormack, Winchester, MA (US)

Correspondence Address: Philip J. McKay;Gunnison, McKay & Hodgson, L. L. P., Suite 220, 1900 Garden Road, Monterey, CA, 93940, US

(73) Assignee: Sun Microsystems, Inc.

(21) Appl. No.: 10/627,020

(22) Filed: Jul. 25, 2003

(51) Int. Cl. G06F 15/16

(52) U.S. Cl. 709/207; 709/204

(57) ABSTRACT

A collaborative shell program links the capabilities of a command line interface (CLI) shell program on a user computer system to the collaborative capabilities of an instant messaging system on an IM server computer system over a network. The collaborative shell program permits one or more users to issue commands to one or more target computer systems through a chat window by preceding the command with a predefined command character. Users can inter-mix commands (delimited by the predefined command character) with standard chat text. Any authorized participant in the chat can issue commands to a target computer system from a chat window and the response is relayed to all the participants.

### BACKGROUND OF THE INVENTION

1. Field of the Invention

The present invention is directed to the field of computer based messaging systems.

2. Description of Related Art

Instant messaging (IM) systems are widely used for sending near real-time messages from one person, e.g., a user, to another person over a network that supports the IM system. Typically one or more IM server computer systems on the network utilize an IM server application that provides the functions and features of the IM system in accordance with a particular IM protocol. Many IM systems also require installation of an IM client application on a user's computer system to provide a user access to the functions and features provided by the IM server application.

Typically, a user opens the IM client application from the user's computer system and logs on to the IM server. A buddy list supported by the IM system is displayed on the user's machine. Conventionally, the buddy list contains a listing of persons selected by the user for inclusion on the buddy list and who can be selected for messaging from the buddy list. In some IM systems, the buddy list also provides an indication of whether a person in the buddy list is actively connected or not.

To send an instant message, the user selects a person from the buddy list, inputs a message into an instant messaging window displayed on the user's computer system, and sends the instant message to the selected person. When the message is sent, it is displayed on the other person's computer system in near real-time.

Many IM systems further include a chat feature that permits two or more users to exchange text messages through a chat session maintained by the IM server(s). In a chat session, the text messages from all users participating in the chat session are viewable in a chat window displayable on each of the users' machines. Typically, the text from each participant and the participant's name are displayed in the chat window to provide a running history of the chat.

Many of the user computer systems on the network are stand-alone computer systems that process data and information utilizing an operating system. Conventionally, a user interface to the operating system is provided by a program called a command line interface (CLI) shell program, or simply, a shell. The CLI shell program can be a default CLI shell program provided with a particular operating system or it can be another CLI shell program selected by a user that is compatible with the particular operating system.

Generally, the CLI shell program allows users to direct the operation of the user's computer system by entering a text command. Many CLI shell programs also permit text commands to be used as a scripting language to perform operations in batch processing mode without user interaction, e.g., a script, a bot, or an agent. Thus, once a script, a bot, or an agent is saved with an identifying name, it can be executed again by simply typing the identifying name into the CLI shell program.

In order to direct the operation of a computer system using the CLI shell program, a user typically inputs the command through the CLI shell program of the computer system. If a user cannot be present at the computer system but has access to another computer system that can access the initial computer system, such as through a direct telnet connection, the user can input commands to the initial computer system.

Disadvantageously other interested persons, such as system administrators, or trainees, at other remote computer systems cannot view or input commands to the initial computer system being accessed by the user. In some instances, the user can echo back a view of the display to the other interested persons, but again the other interested persons cannot input commands to the initial computer system. If the other interested persons wish to discuss any of the commands or the responses to the commands, typically the other interested persons have to telephone, e-mail or message one another or the user separate from the telnet connection.

### SUMMARY OF THE INVENTION

According to the invention, in one embodiment, a collaborative shell program links the command line interface (CLI) of an existing CLI shell program on a user computer system to the instant messaging/chat capabilities of an existing instant messaging (IM) system to permit a user to issue commands to one or more target computer systems through a chat window over a network. In one embodiment, the invention permits one or more users at different user computer systems to issue commands to one or more different target computer systems through a shared chat window over the network. Where multiple users are involved, the invention permits collaborative intermixing of chat text and commands in the shared chat window.

In one embodiment, a predefined command character is used to denote subsequent text as a command that is issued to a selected target computer system.

The invention provides lightweight awareness and monitoring of target computer systems, scripts, bots, agents, and other persona through the use of buddy lists, collaborative chat windows, and cross platform push notification of alerts.

In one embodiment, the invention permits authentication of users to one or more target computer systems.

In one embodiment, the invention permits text messages to be relayed using a single IM protocol to desktop applications, browsers, pagers, cell phones, personal digital assistants (PDAs), and other devices that can support the IM protocol, such as through the presence of an IM client application compatible with the IM protocol.

It is to be understood that both the foregoing general description and following detailed description are intended only to exemplify and explain the invention as claimed.

### BRIEF DESCRIPTION OF THE DRAWINGS

The accompanying drawings, which are incorporated in, and constitute a part of this specification, illustrate embodiments of the invention, and together with the description, serve to explain the invention. In the drawings, the same reference numbers are used to denote similar components in the various embodiments.

In the drawings:

FIG. 1 illustrates a diagram of a synchronous, collaborative, shell-integrated IM system including a collaborative shell program according to one embodiment of the invention;

FIG. 2 illustrates a functional diagram of a process implemented by synchronous collaborative shell-integrated IM system 100 in accordance with one embodiment of the invention;

FIG. 3 illustrates an example of a buddy list and chat window generated by the synchronous collaborative shell-integrated IM system of FIG. 1 and displayed on a user computer system in accordance with one embodiment of the invention;

FIG. 4 illustrates a functional diagram of a process implemented by the synchronous collaborative shell-integrated IM system of FIG. 1 in accordance with another embodiment of the invention;

FIG. 5 illustrates an example of a buddy list and chat window generated by the synchronous collaborative shell-integrated IM system of FIG. 1 and displayed on a user computer system in accordance with one embodiment of the invention;

FIG. 6 illustrates a functional diagram of a process implemented by the synchronous collaborative shell-integrated IM system of FIG. 1 in accordance with another embodiment of the invention;

FIG. 7 illustrates a split view of exemplar individual buddy lists and a view of a shared chat window generated by the synchronous collaborative shell-integrated IM system of FIG. 1 and displayed on user computer systems in accordance with one embodiment of the invention;

FIG. 8 illustrates an example of a buddy list and two chat windows generated by the synchronous collaborative shell-integrated IM system of FIG. 1 and displayed on a user computer system in accordance with one embodiment of the invention;

FIG. 9 illustrates an example of an alert message window generated by the synchronous collaborative shell-integrated IM system of FIG. 1 and displayed on a user computer system in accordance with one embodiment of the invention;

FIG. 10 illustrates a functional diagram of a process implemented by the synchronous collaborative shell-integrated IM system of FIG. 1 in accordance with one embodiment of the invention; and

FIG. 11 illustrates an example of a view of a shared chat window generated by the synchronous collaborative shell-integrated IM system of FIG. 1 and displayed on user computer systems participating in the session of FIG. 11 in accordance with one embodiment of the invention.

### DETAILED DESCRIPTION

The invention will now be described in reference to the accompanying drawings. The same reference numbers may be used throughout the drawings and the following description to refer to the same or like parts.

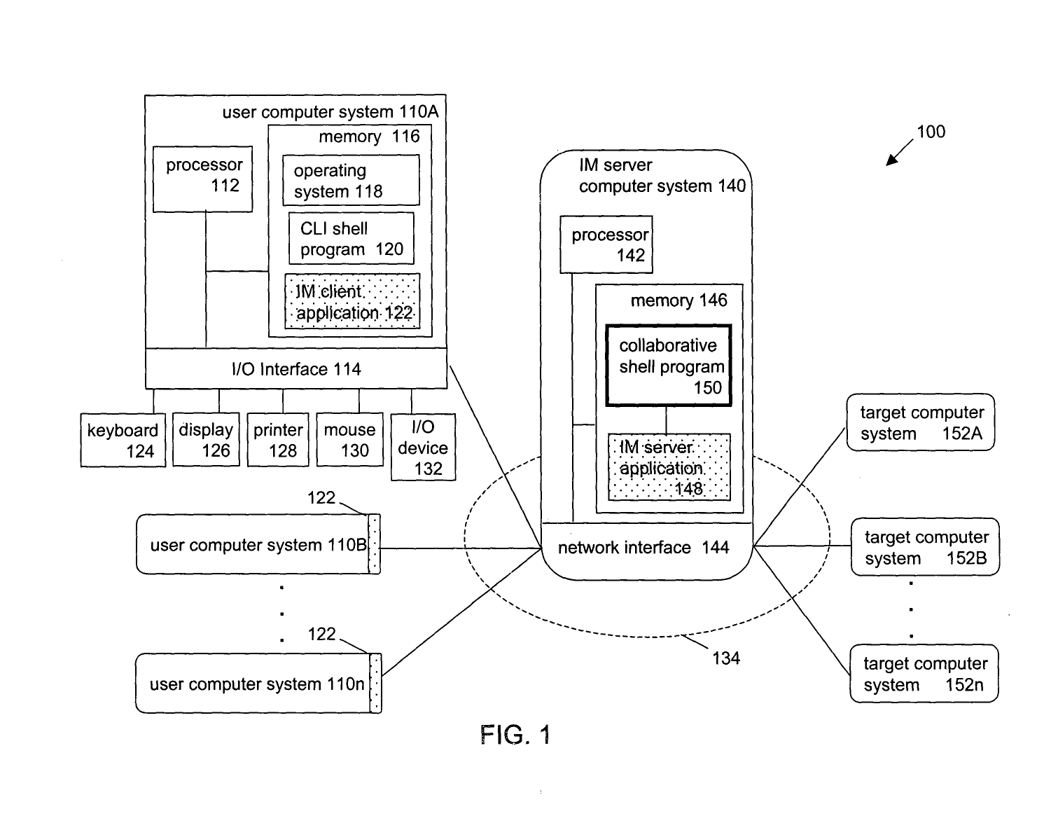

FIG. 1 illustrates a diagram of a synchronous, collaborative, shell-integrated IM system 100, hereinafter referred to as shell-integrated IM system 100, including a collaborative shell program 150 according to one embodiment of the invention. In one embodiment, collaborative shell program 150 integrates, or links, the command line interface (CLI) of a CLI shell program 120 on a user computer system 110A to the collaborative capabilities of an instant messaging (IM) system supported by an IM server application 148 on IM server computer system 140 as further described herein.

As illustrated in FIG. 1, in one embodiment, user computer systems 110A-110n represent stand-alone target computer systems, sometimes called client or user devices. For example, user computer system 110A typically includes a processor 112, an input/output (I/O) interface 114, and a memory 116. User computer system 110A can further include standard devices, such as a keyboard 124, a display 126, a printer 128, a mouse 130, as well as one or more standard I/O devices 132, such as a compact disk (CD) or DVD drive, floppy disk drive, or other digital or waveform port for inputting data to and outputting data from user computer system 110A. In some embodiments, keyboard 124 can be another input device, such as a digital pad, digital stylus, or wave form port, that permits user input to user computer system 110A. In some embodiments, I/O interface 114 can include analog modems, digital modems, optical modems, or a network interface card.

In the present embodiment, memory 116 includes an operating system 118, CLI shell program 120, and an IM client application 122. Memory 116 can be a single memory structure as illustrated in FIG. 1 or can be multiple memory structures.

Operating system 118 is used to control the functions of user computer system 110A. Operating system 118 can be any operating system, such as a UNIX, a LINUX, or a Windows®-based operating system, among others.

CLI shell program 120 includes a command line interface (CLI) that permits a user to issue text commands and direct operation of user computer system 110A. CLI shell program 120 can be one of several CLI shell programs compatible with operating system 118. For example, if operating system 118 is a UNIX operating system, CLI shell program 120 can be a C shell program, a Bourne shell program, a Bourne-Again shell program, or a Korn shell program, among others.

IM client application 122 is a lightweight application resident on user computer system 110A that provides the necessary interface needed for user computer system 110A to utilize the capabilities of the IM protocol supported by IM server application 148. In one embodiment, IM client application 122 is modeled after the existing IM server application 148, such as AOL Instant Messenger®, Yahoo Messenger®, MSN Windows Messenger®, and Lotus Sametime Connect®, among others. In one embodiment, IM client application 122 permits a user to authenticate to IM server computer system 140.

In FIG. 1, IM server computer system 140 is communicatively coupled with user computer systems 110A-110n and target computer systems 152A-152n, such as servers, switches, or routers, by a network 134. In the present embodiment, network 134 allows access to target computer systems 152A-152n through a session connection, such as telnet and ftp.

In one embodiment, authentication of a user on user computer systems 110A-110n is propagated through IM server computer system 140 to target computer systems 152A-152n allowing rights to be managed by IM server computer system 140. Additionally, IM server computer system 140 is capable of issuing commands to start and stop status profiling processes on one or more of target computer systems 152A-152n. Again, in one embodiment, proper authentication is propagated through IM server computer system 140 to target computer systems 152A-152n. If other authenticated users are interested in the same profiling information, IM server computer system 140 need not start independent processes.

In the present embodiment, IM server computer system 140 includes: a processor 142; a memory 146; a network interface 144; collaborative shell program 150; and, IM server application 148. IM server computer system 140 can further include I/O devices, such as a keyboard, a display, a printer, a mouse, as well as other I/O devices, not shown.

In one embodiment, IM server computer system 140 executes IM server application 148, and IM server application 148 permits IM client application(s) 122 to connect. In one embodiment, IM server 140 opens a session connection, such as a telnet session, ftp session, or other session connection with a user computer system, such as user computer system 110A, and, in some embodiments, opens additional connections to some or all of user computer systems 110B-100n and target computer systems 152A-152n.

IM server application 148 is able to accept and relay events to all or a subset of connected users on user computer systems 110A-100n and/or connected target computer systems 152A-152n. Input sent via events from IM client application(s) 122 can be relayed through the session connection and responses relayed back to IM client application(s) 122.

In one embodiment, IM server application 148 and collaborative shell program 150 are stored in memory 146 and executed on IM server computer system 140. In other embodiments, multiple memories 146 and/or IM server computer systems 140 can be used.

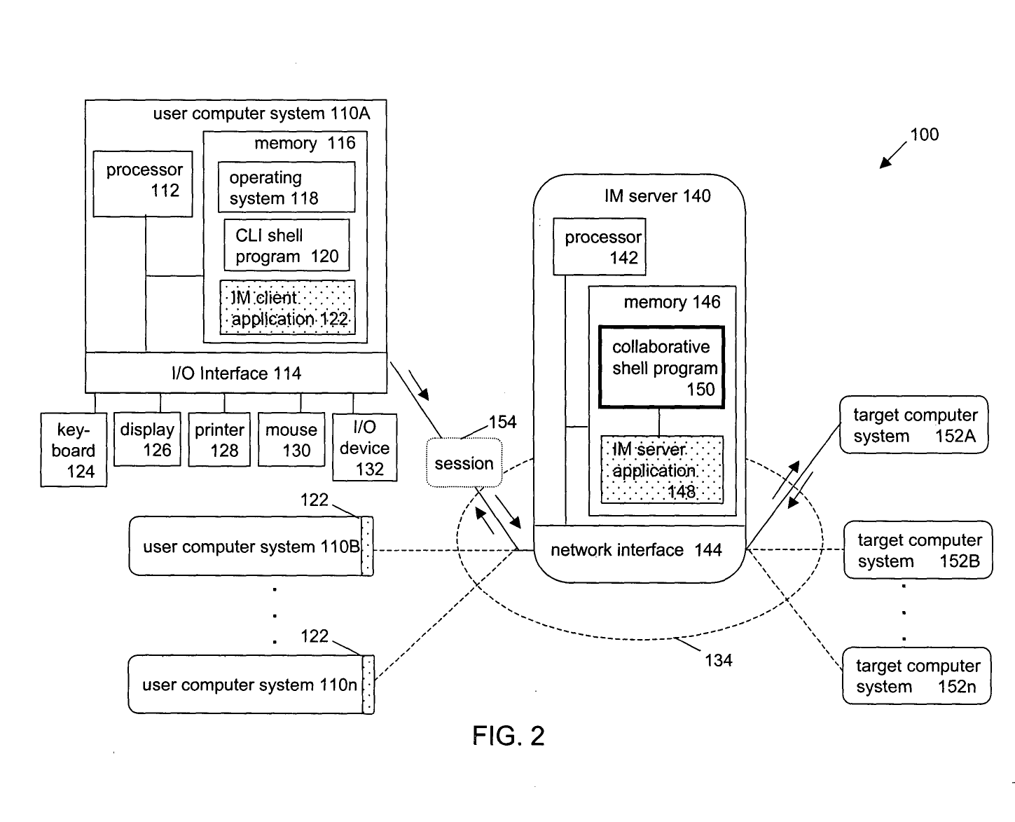

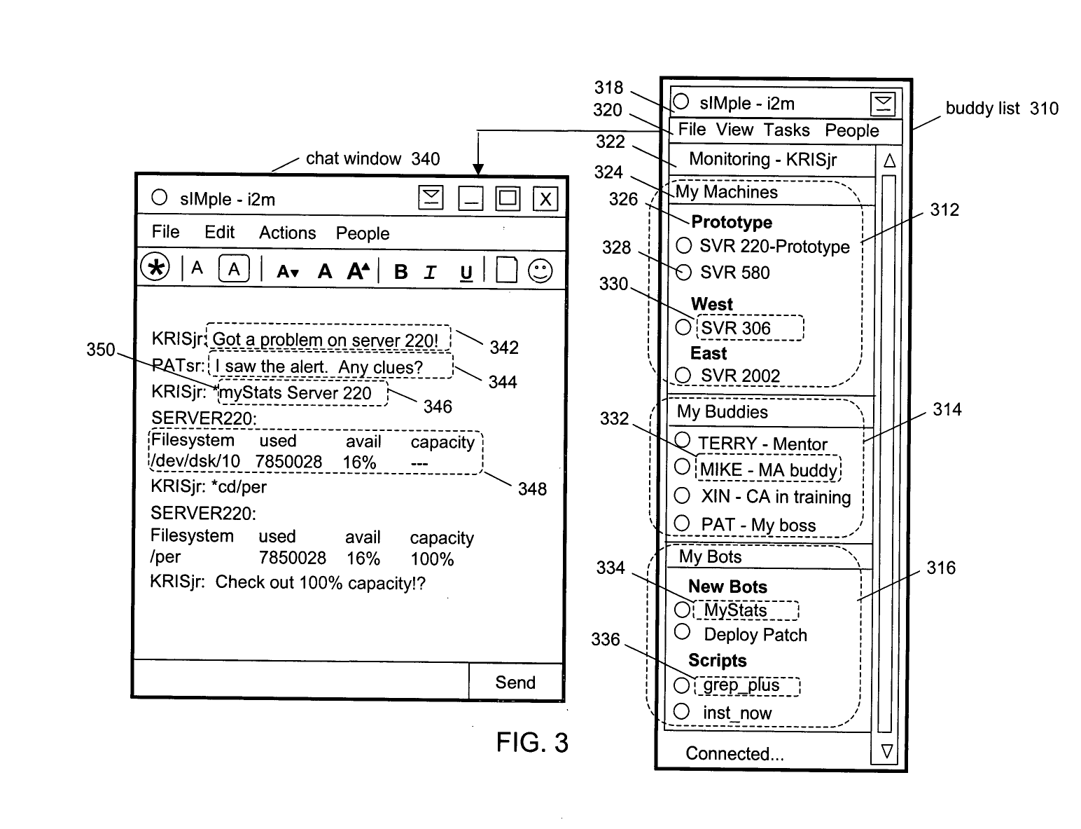

FIG. 2 illustrates a functional diagram of a process implemented by synchronous collaborative shell-integrated IM system 100 in accordance with one embodiment of the invention. FIG. 3 illustrates an example of a buddy list 310 and chat window 340 generated by synchronous collaborative shell-integrated IM system 100 and displayed on user computer system 110A in accordance with one embodiment of the invention.

Referring now to FIGS. 2 and 3 together, in one embodiment, a user on user computer system 110A opens IM client application 122 and is prompted for a user name and a password. Upon successful entry, the user is authenticated to IM server computer system 140, an open socket is maintained between IM server computer system 140 and IM client application 122, a session connection is established, and a session 154 is started. Authentication and authentication procedures are well known to those of skill in the art and are not further described herein to avoid detracting from the invention.

In one embodiment, IM client application 122 displays a first graphical user interface, such as buddy list 310, on user computer system 110A. In one embodiment, buddy list 310 contains selected names, or identifiers, of other individuals registered on IM server computer system 140 and/or selected names, or identifiers, of other target computer systems, such as servers, routers, and switches, that are on network 134. In the present embodiment, buddy list 310 further includes selected names, or identifiers, of scripts, bots, or agents. Buddy list 310 is further described herein.

When the user of user computer system 110A selects a target computer system, for example target computer system 152A, in buddy list 310, such as by double clicking on “SVR 220”, an event is sent to IM server computer system 140. The event instructs IM server computer system 140 to open an additional connection within session 154 to “SVR 220”, e.g., target computer system 152A,

Depending on the desired level of security, in one embodiment, the user is further prompted to authenticate to “SVR 220”, e.g., target computer system 152A. In one embodiment, a user on user computer system 110A is prompted for a user name and a password. The data entered by the user is relayed through IM server computer system 140 to target computer system 152A and the additional connection is opened and maintained by IM server computer system 140.

After the user has successfully connected to target computer system 152A via IM server computer system 140, a second graphical user interface, such as chat window 340 is displayed on user computer system 110A. As illustrated in FIG. 3, chat window 340 supports an input text field, such as input text field 342, displaying a user's input text, and an output text field, such as output text field 344, displaying output text.

In the present embodiment, once session 154 is started between the user via user computer system 110A and target computer system 152A (and any authentication requirements met), the user is able to issue commands to target computer system 152A by inputting a predefined command character followed by a command to chat window 340. For example, in one embodiment, the user inputs text including a predefined command character 350, such a first character, followed by a command 346, such as the remaining subsequent characters.

In one embodiment, incoming text from client application 122 to IM server computer system 140 is intercepted by collaborative shell program 150. In one embodiment, collaborative shell program 150 includes a proxy function that intercepts incoming text to IM server computer system 140 and determines whether or not the first character of the incoming text is predefined command character 350. Upon a determination that the first character of the incoming text is not predefined command character 350, the text is passed to IM server application 148 for standard processing. Upon a determination that the first character of the incoming text is predefined command character 350, the subsequent characters, e.g., command 346, is interpreted as a command and submitted through session 154 to target computer system 152A, e.g., “SVR 220”.

In one embodiment, the choice of predefined command character 350 is dependent upon CLI shell program 120. Predefined command character 350 should be a character not already utilized by CLI shell program 120, and thus is available by collaborative shell program 150 to identify commands.

In one embodiment, the output from the command, such as a response 348 from target computer system 152A, is automatically relayed back to IM client application 122 through session 154 and displayed in chat window 340. In one embodiment, the output is appended to the end of the output text field. In one embodiment, when the user on user computer system 110A closes chat window 340, session 154 is terminated by IM server computer system 140 and the socket closed.

Thus, as described above, in one embodiment, shell-integrated IM system 100 permits a user to issue a command from a user computer system 110A-110n to a target computer system 152A-152n over network 134 through session 154 by inputting the command preceded by predefined command character 350 to chat window 340.

Referring again to FIG. 3, in one embodiment, buddy list 310 includes a target computer systems field 312, a persons field 314, and a scripts/bots/agents field 316 for accessing and monitoring status awareness of people, target computer systems, scripts, bots, and/or agents as further described herein. In the present embodiment, buddy list 310 further includes a title bar 318, a task bar 320, and an identifier bar 322.

Title bar 318 includes the title of synchronous collaborative shell-integrated IM system 100, for example, “sIMple”, and can include further version designators, for example, “i2m”. Task bar 320 includes various tasks, such as file, view, task, and/or listings of people on network 134. In some embodiments, a listing of computer systems on network 134 can be included. Identifier bar 322 includes the identifier of the monitoring user, for example, “KRISjr”.

In the present embodiment, field identifiers, such as field identifier 324, are default or user determined titles that act to organize and identify selected areas, or fields, of buddy list 310, such as “My Machines”, “My Buddies”, and “My Bots”. Field sub-headers, such as field sub-header 326, are used to further organize and identify selected areas under field identifiers 324.

In one embodiment, field identifiers, such as field identifier 324, and/or field sub-headers, such as field sub-header 326, establish selectable groupings that permit a user to perform an action on the item(s) within the group. For example, in one embodiment, by selecting field sub-header 326, “Prototype”, such as by right clicking on a mouse, a user can perform an action, such as applying a software patch, to all the target computer systems within “Prototype”, e.g., SVR 220 and SVR 580.

In the present embodiment, buddy list 310 includes selectable listings of target computer systems, such as target computer system 330, e.g., “SVR 306”, people, such as person 332, e.g., “MIKE-MA buddy”, and scripts, bots, and/or agents, such as script 336, e.g., “grep_plus”, and bot 334, e.g., “MyStats”. A status indicator 328 is located along with a particular selectable item, such as a target computer system, for example, target computer system 330, and/or a person, for example, person 332, to provide a status awareness of the selected item, such as actively connected or not actively connected, or an alarm status, in reference to a target computer system.

In some embodiments, status indicator 328 is also associated with scripts, bots, and/or agents to indicate a loading, an executing, an inactive, or an alarm status. In some embodiments, status indicator 328 can be used in title bar 318 to indicate the status of synchronous collaborative shell-integrated IM system 100, IM server application 148, or network 134.

In one embodiment, a user on user computer system 110A selects, or sets, a list of target computer systems to monitor, such as selected ones of target computer systems 152A-152n. IM server computer system 140 periodically queries, or pings, the selected target computer systems 152A-152n for status information. In one embodiment, the status information is utilized by shell-integrated IM system 100 in generating status indicator 328 to provide the user an indication of the status of each selected target computer system 152A-152n in buddy list 310, such as by selectively coloring, patterning, or otherwise visually altering or audibly alarming a status indicator 328 next to a selected computer system 152A-152n to represent a particular status level.

Thus, as described above, shell-integrated IM system 100 provides status awareness of people, target computer systems, scripts, bots, and/or agents by gathering status information and displaying it to a user in a buddy list, such as buddy list 310, supported by IM client application 122.

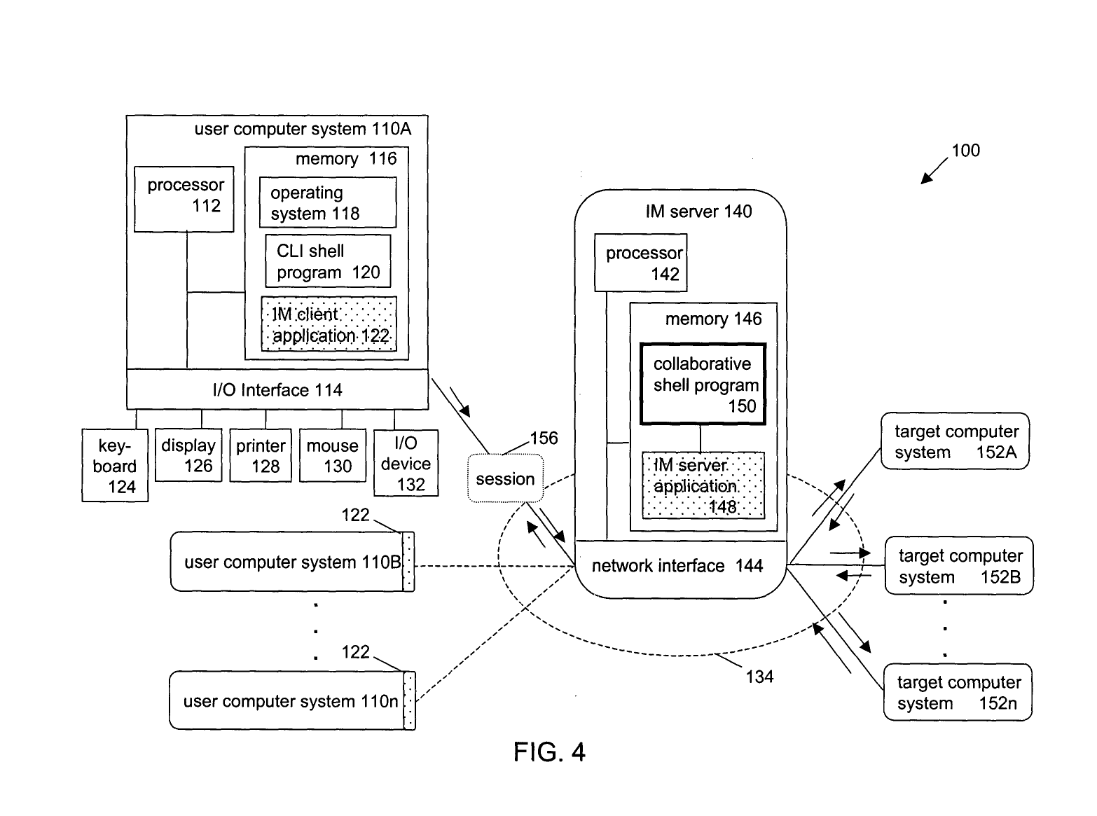

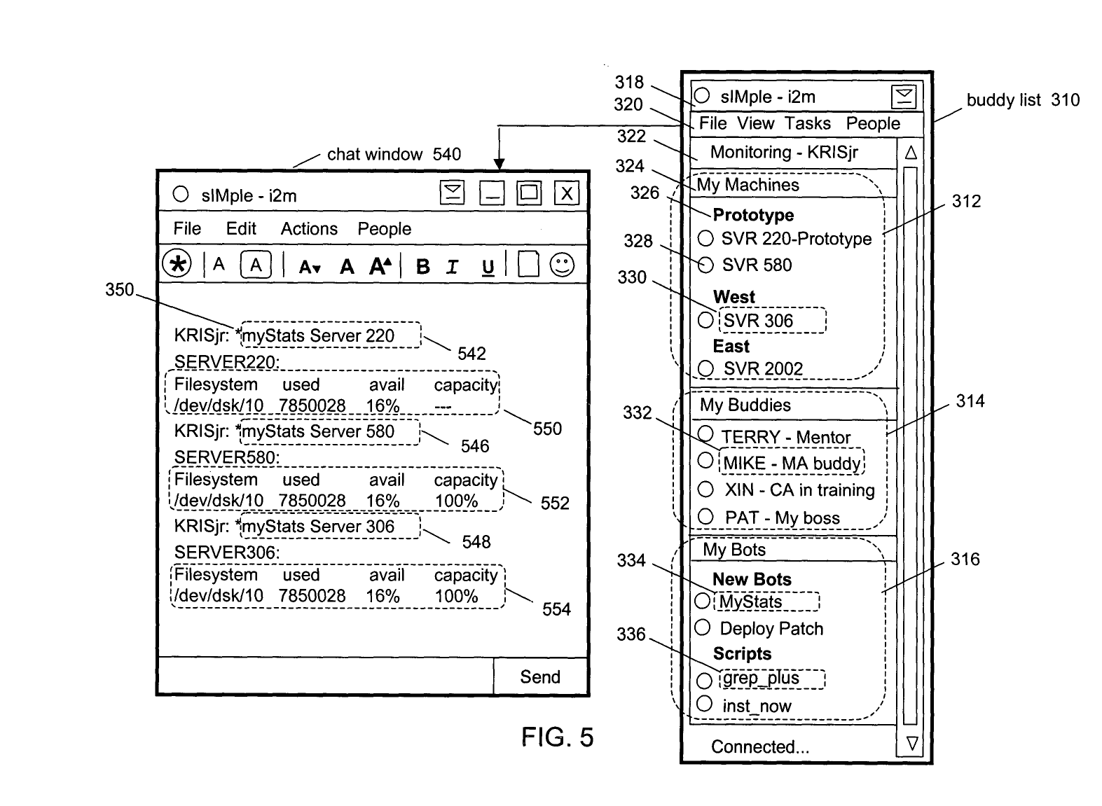

FIGS. 1-3 described a process implemented by shell-integrated IM system 100 in which a user issues a command (delimited by predefined command character 350) from a user computer system 110A-110n to a target computer system 152A-152n through a session. Additionally, a user on a user computer system 110A-110n can issue a command to multiple target computer systems 152A-152n described herein with reference to FIGS. 4 and 5.

FIG. 4 illustrates a functional diagram of a process implemented by synchronous collaborative shell-integrated IM system 100 in accordance with another embodiment of the invention. FIG. 5 illustrates an example of a buddy list 310 and a chat window 540 generated by synchronous collaborative shell-integrated IM system 100 and displayed on user computer system 110A in accordance with one embodiment of the invention.

Referring to FIGS. 1, 4 and 5 together, in one embodiment, a user on user computer system 110A opens IM client application 122 and is prompted for a user name and a password. Upon successful entry, the user is authenticated to IM server computer system 140, an open socket is maintained between IM server computer system 140 and IM client application 122, a session connection is established, and a session 156 is started.

In one embodiment, IM client application 122 displays a first graphical user interface on user computer system 110A, such as earlier described buddy list 310. In one embodiment, the user on user computer system 110A selects particular target computer systems 152A-152n to be included in session 156. For example, in some embodiments, the user can select particular target computer systems 152A-152n in buddy list 310, such as by individually selecting particular target computer systems 152A-152, or by using a multi-select function and clicking on “SVR 220”, “SVR 580”, and “SVR 306”. In another embodiment, the user can select a single target computer system, such as target computer system 152A, and can also select other target computer systems, such as target computer systems 152B-152n, through an invitation window supported by IM client application 122. Selection of the particular target computer systems 152A-152n generates an event that is sent to IM server computer system 140. The event instructs IM server computer system 140 to open additional connections within session 156 to each of the selected target computer systems 152A-152n, e.g., “SVR 220”, “SVR 580”, and “SVR 306”.

Depending on the desired level of security, in one embodiment, the user on user computer system 110A is further prompted to authenticate to each of the selected target computer systems 152A-152n, e.g., “SVR 220”, “SVR 580”, and “SVR 306”. In one embodiment, a user on user computer system 110A is prompted for a user name and a password. The data entered by the user is relayed through IM server computer system 140 to each of the selected target computer systems 152A-152n and the additional connections are opened and maintained by IM server computer system 140 to each of the specified target computer systems 152A-152n, e.g., “SVR 220”, “SVR 580”, and “SVR 306”.

After the user has successfully connected to target computer systems 152A-152n via IM server computer system 140, a second graphical user interface, such as chat window 540, is displayed on user computer system 110A. In the present embodiment, once session 156 is started between the user via user computer system 110A and the selected target computer systems 152A-152n, the user is able to issue commands to one or more of selected target computer systems 152A-152n by inputting the commands preceded by predefined command character 350 to chat window 540, as earlier described with reference to FIGS. 1-3. For example, the user can issue commands 542, 546 and 548, to each of the selected target computer systems 152A-152n, e.g., “SVR 220”, “SVR 580”, and “SVR 306”, respectively.

In one embodiment, the response to the command from each of selected target computer systems 152A-152n, e.g., “SVR 220”, “SVR 580”, and “SVR 306”, is automatically relayed back to IM client application 122 through session 156, for example, responses 550, 552, and 554, respectively. In one embodiment, the output response is appended to the end of the output text field in chat window 540.

In one embodiment, batch results automatically output to session 156 and display in chat window 540 on user computer system 110A. In another embodiment, batch results automatically trigger an instant message when complete.

In one embodiment, when the user on user computer system 110A closes chat window 540, session 156 is terminated by IM server computer system 140 and connections to target computer systems 152A-152n, e.g., “SVR 220”, “SVR 580”, and “SVR 306”, are closed.

Thus, as described above, in one embodiment, shell-integrated IM system 100 permits a user to issue commands from a user computer system 110A to more than one target computer system 152A-152n over network 134 through session 156 by inputting the commands preceded by predefined command character 350 to chat window 540.

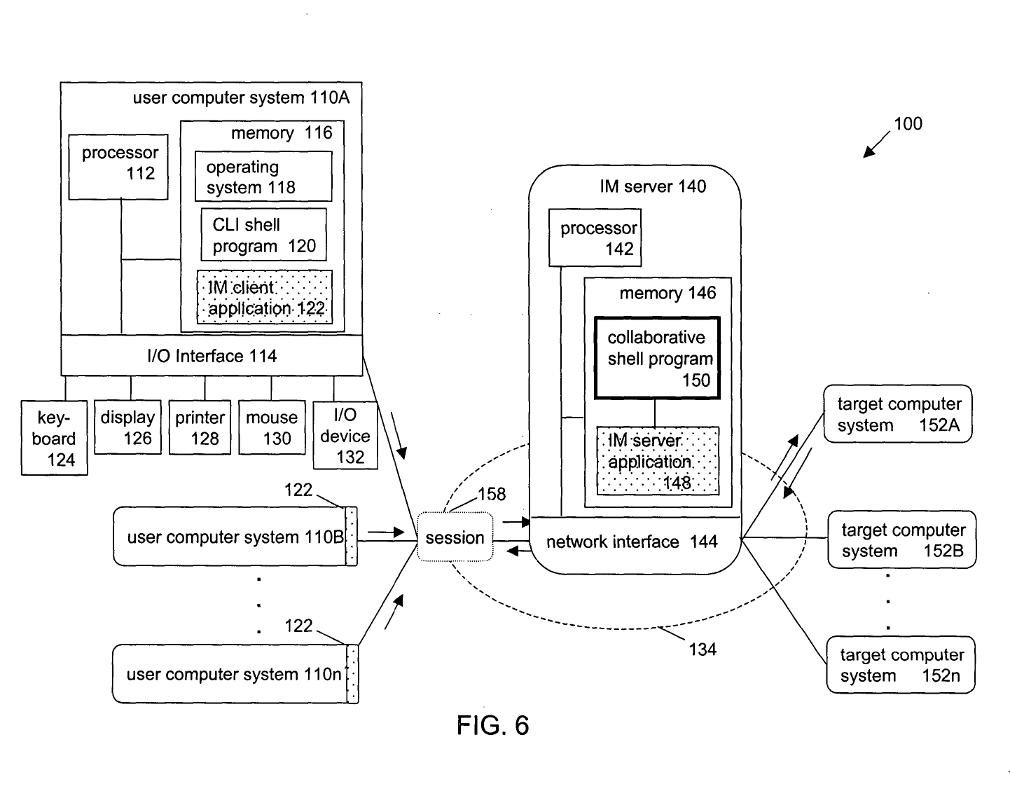

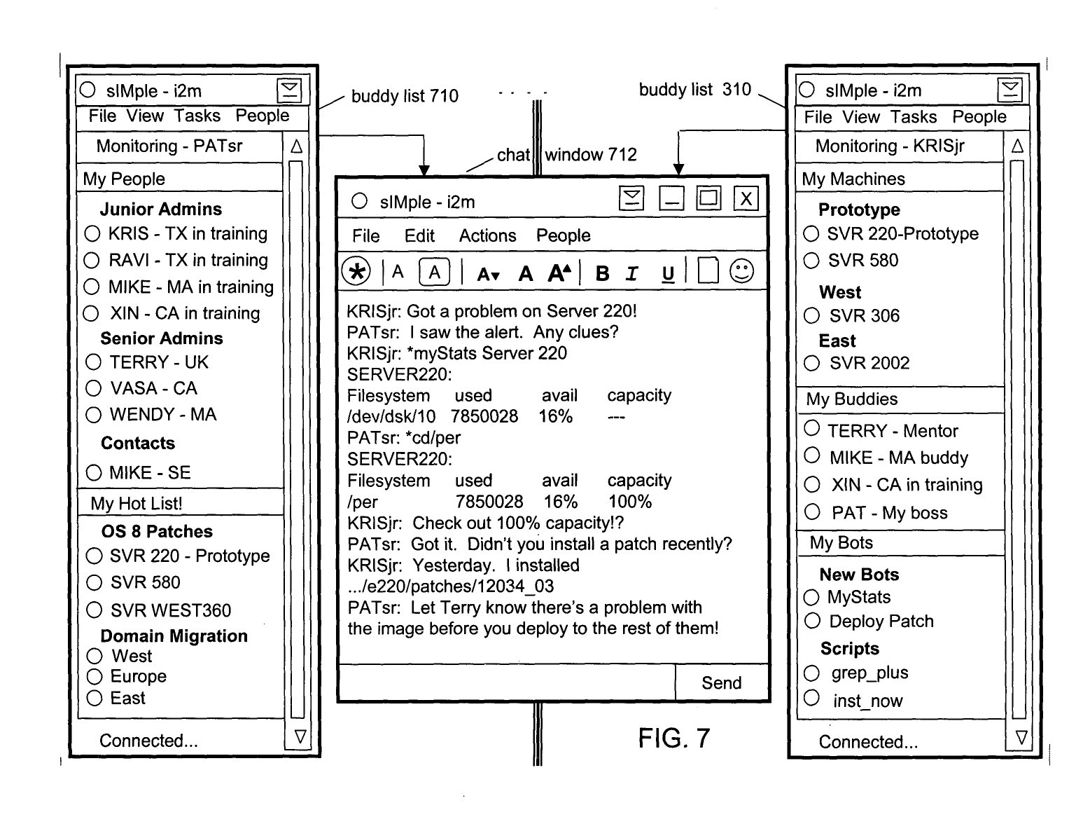

FIG. 6 illustrates a functional diagram of a process implemented by synchronous collaborative shell-integrated IM system 100 in accordance with another embodiment of the invention. FIG. 7 illustrates a split view of exemplar individual buddy lists 310 and 710 and a view of shared chat window 712 generated by synchronous collaborative shell-integrated IM system 100 and displayed on user computer systems 110A and 110B in accordance with one embodiment of the invention.

Referring to FIGS. 1, 6 and 7 together, in one embodiment, a user on user computer system 110A opens IM client application 122 and is prompted for a user name and a password. Upon successful entry, the user is authenticated to IM server computer system 140, an open socket is maintained between IM server computer system 140 and IM client application 122, a session connection is established, and a session 158 is started.

In one embodiment, IM client application 122 displays a first graphical user interface, such as buddy list 310, on user computer system 110A. In one embodiment, the user selects one or more target computer systems 152A-152, such as target computer system 152A, and one or more other users on user computer systems 110B-110n, for example, user “PATsr” on user computer system 110B, from buddy list 310 and an event is sent to IM server computer system 140.

Similar to the selection of one or more target computer systems 152A-152n earlier described, in some embodiments, the user can select one or more other users from buddy list 310 using individual selections or a multi-select function. In another embodiment, the user can select one or more other users from an invitational window supported by IM client application 122.

The events instruct IM server computer system 140 to open additional connections within session 158 to target computer system 152A and the selected user computer systems 110A-110n, for example user computer system 110B. In one embodiment, depending on the desired level of security, user computer system 110A as well as each of the selected users of user computer systems 110B-110n, for example, “PATsr”, are each prompted to authenticate to target computer system 152A, independently. In one embodiment, authentication to target computer system 152A is propagated through session 158 for each issuer of commands, and the rights for each individual are maintained on IM server computer system 140.

In the present embodiment, once session 158 is open between one or more of user computer systems 110A-110n and target computer system 152A, any participating user is able to issue commands to target computer system 152A as earlier described with reference to FIGS. 1-3. For the sake of simplicity, it is assumed that the act of inviting others into session 158 allows each of the users control based on each user's credentials, and that, in this embodiment, each of the other users, e.g., “PATsr”, have authorization to issue commands to target computer system 152A.

In the present embodiment, the users can inter-mix commands (delimited by predefined command character 350, for example, “*”) with standard chat text. In this manner, users can chat and additionally send commands to a specified server, e.g., target computer system 152A. Any participant in the chat can issue commands (by preceding the command with predefined command character 350) and the responses are relayed to all connected users through session 158 for display in each user's chat window. In one embodiment, the output is appended to the end of the output text field.

Referring to FIG. 7, for example, assume that buddy list 310 is displayed to “KRISjr”, e.g., a first user, on user computer system 110A that is connected to session 158. Buddy list 710 is displayed to “PATsr”, e.g., a second user, on user computer system 110B that is also connected to session 158. Chat window 712 is commonly displayed on user computer system 111A and user computer system 10B, e.g., the first user and the second user have a shared view of chat window 712.

Note that in accordance with the invention, buddy list 710 can be differently formatted from buddy list 310 and yet still contain listings of people and computer systems, and can, in still other embodiments, include scripts, bots, and agents listings. In one embodiment, buddy list 710 includes single identifiers that represent multiple computer systems, e.g., “WEST”, “EUROPE” and “EAST”. In this way, groups of computer systems can be monitored, for example, by a script monitoring the progress of a patch installation, and the status indicated in buddy list 710.

As illustrated in chat window 712, the first user, e.g., “KRISjr”, and the second user, e.g., “PATsr”, can intermix text and commands (delimited by the predefined command character 350, for example, “*”). This allows the first user and second user to collaboratively address a problem with both the first user and the second user being able to issue commands to a particular target computer system, e.g., target computer system 152A, from shared chat window 712.

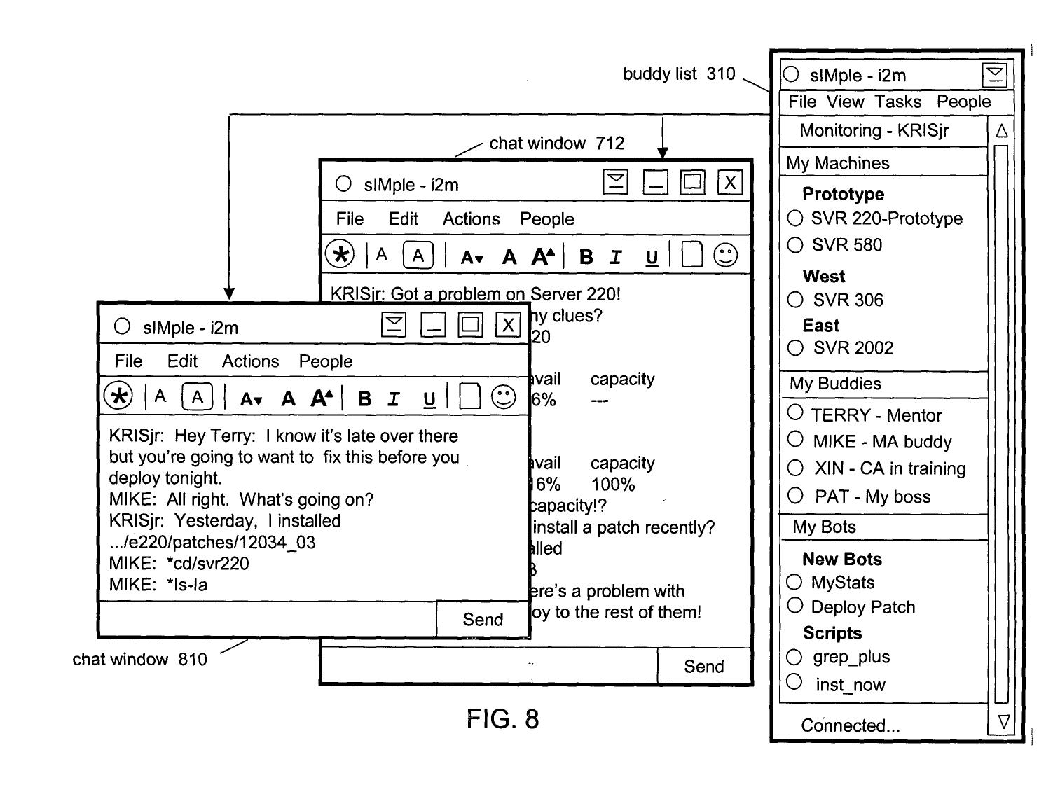

In one embodiment, either user in session 158 can open other connections independent of session 158 as further described with reference to FIG. 8.

FIG. 8 illustrates an example of buddy list 310, chat window 712, and a chat window 810 generated by synchronous collaborative shell-integrated IM system 100 and displayed on user computer system 110A in accordance with one embodiment of the invention. Referring now to FIGS. 1, and 6-8 together, in one embodiment, the first user, e.g., “KRISjr”, has established a separate session connection utilizing synchronous collaborative shell-integrated IM system 100, such as another session connection, to a third user, e.g., “MIKE”, that is independent of session 158. Again, as described with reference to session 158, both the first user, e.g., “KRISjr”, and the third user, e.g., “MIKE”, can intermix text and commands (delimited by the predefined command character 350).

In the present example, the third user, e.g., “MIKE”, has been authenticated to target computer system 152A, and can also issue commands to target computer system 152A, e.g., “SVR 220”, but through a different session independent of session 158. Thus, in this embodiment, the third user, e.g., “MIKE”, views chat window 810, but would not share a view of chat window 712 as the third user is not a participant in session 158. In one embodiment, when all participants in a session have closed their chat windows, the session is terminated by IM server computer system 140, and the sockets are closed.

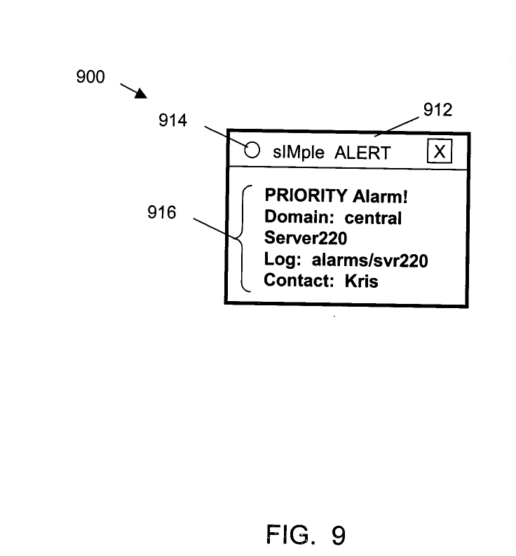

In one embodiment, shell-integrated IM system 100 can also push cross-platform alerts or other text messages to user computer systems 110A-110n as further described with reference to FIG. 9.

FIG. 9 illustrates an example of an alert message window 900 generated by synchronous collaborative shell-integrated IM system 100 and displayed on a user computer system 110A-110n in accordance with one embodiment of the invention. Referring to FIGS. 1 and 9 together, in one embodiment, synchronous collaborative shell-integrated IM system 100 permits alert or other text messages to be displayed on a user computer system 110A-110n.

In this embodiment, a user computer system 110A-110n can be any user computer system that includes IM client application 122, or other client application that enables communication to IM server computer system 140 and can interact with the IM protocol utilized by IM server application 148. Thus, for example, consumer embedded user computer systems that receive text messaging, such as cell phones, personal digital assistants (PDAs), can receive text messages using synchronous collaborative shell-integrated IM system 100.

In this embodiment, a particular user computer system 110A-110n does not have to have a resident CLI shell program 120 with CLI capabilities to receive and respond to the messages included in an alert message window, such as alert message 900. However, in order to issue a command to a target computer system 152A-152n the user computer system 110A-110n needs a CLI shell program, such as CLI shell program 120, or its functional equivalent, that is compatible with synchronous collaborative shell-integrated IM system 100. Thus, in this embodiment, users of consumer embedded computer products that include IM client application 122 functions but not CLI shell program 120 functions, can view text and commands issued in a chat window, such as chat windows 712 and 810 (FIG. 8), even though those users cannot actively input a command.

As illustrated in FIG. 9, alert message window 900 can include a title bar 912 and alarm message 916. In the present embodiment, alert message window 900 further includes a status indicator 914 to indicate a level of alert associated with alarm message 916.

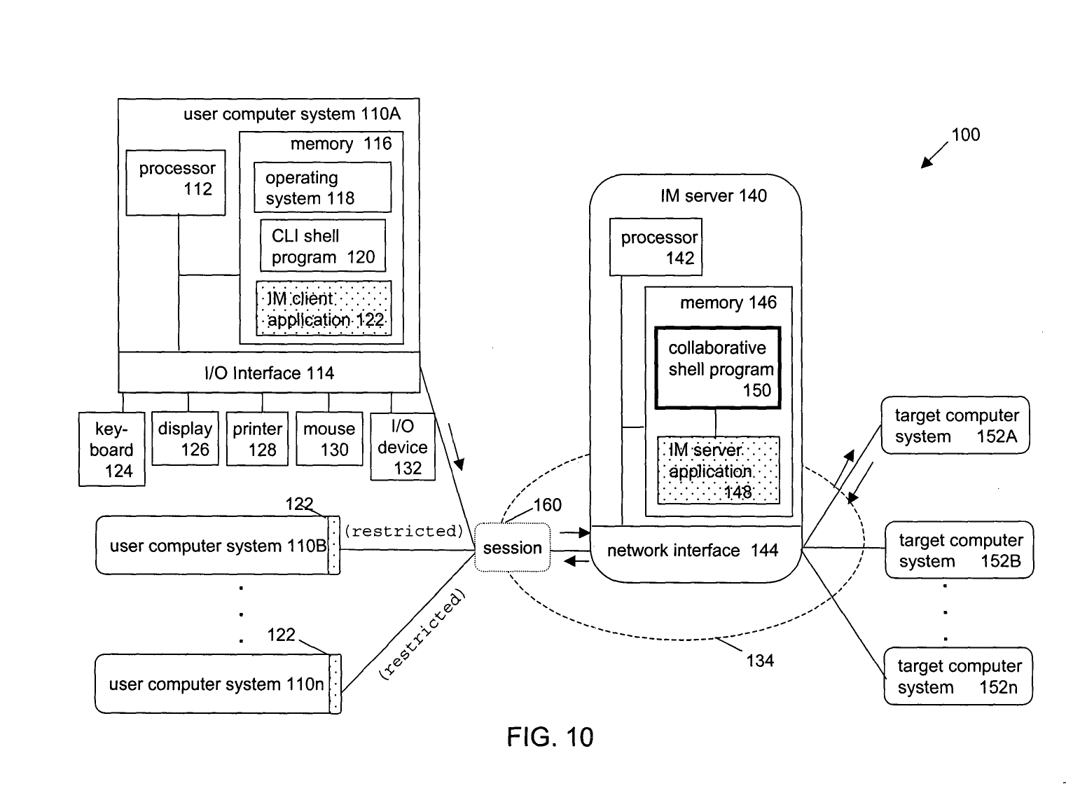

FIGS. 6-8 illustrate one example of an embodiment of the invention in which all the users on participating user computer systems 110A-110n are authenticated for command access to target computer system 152A. In other instances, some of the users participating in a session may have restricted access rights and do not have command access to a target computer system, such as target computer system 152A. As further described herein with reference to FIG. 10, in one embodiment, the present invention permits these users (that are not authenticated for command access to a particular target computer system) to participate in the chat aspect of a session, but not issue commands.

FIG. 10 illustrates a functional diagram of a process implemented by synchronous collaborative shell-integrated IM system 100 in accordance with another embodiment of the invention. Referring to FIGS. 1 and 10 together, in one embodiment, the user on user computer system 110A opens IM client application 122 and is prompted for a user name and a password. Upon successful entry, the user is authenticated to IM server computer system 140, an open socket is maintained between IM server computer system 140 and IM client application 122, a session connection is established, and a session 160 started.

IM client application 122 displays a first graphical user interface, such as buddy list 310, on user computer system 110A. In one embodiment, selects particular target computer systems 152A-152n, such as target computer system 152A, and one or more other users on user computer systems 110B-110n and the events are sent to IM server computer system 140.

The events instruct IM server computer system 140 open additional connections within session 160 to the selected target computer systems 152A-152n, such as target computer system 152A, and opens a socket to each of the selected user computer systems 110A-110n. In one embodiment, depending on the desired level of security, each user of user computer systems 110A-110n are prompted to authenticate to the selected target computer systems 152A-152n, such as target computer system 152A, independently.

In the present embodiment, for purposes of illustration, the user of user computer system 110A is the only user that is authorized to issue commands to target computer system 152A. It is within the session initiating user's decision, e.g., the user of user computer system 110A, to invite other users on user computer systems 10B-110n to session 160 and allow them to see the text, commands, and responses made to the commands. An attempt by any of the other users of user computer systems 110B-110n to submit commands to target computer system 152A will fail since they are not authenticated for command access to target computer system 152A.

In one embodiment, IM server computer system 140 does not need to duplicate rights and permissions. IM server computer system 140 relays the authentication and allows target computer system 152A to handle conflicts as it would in a normal command line interface.

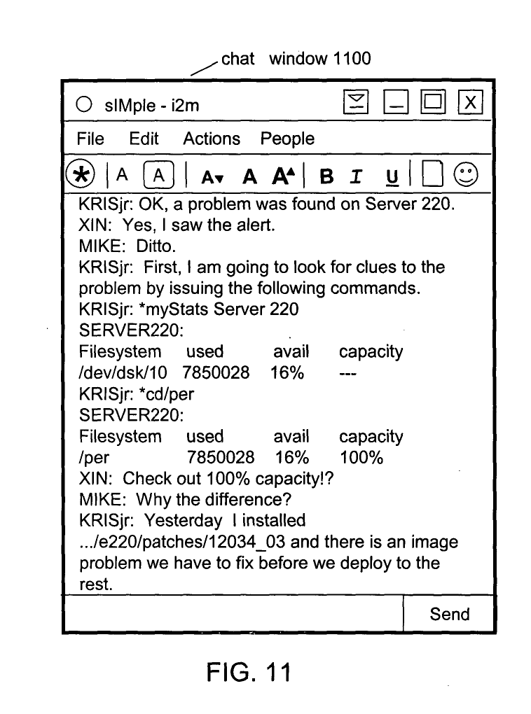

In one embodiment, the user on user computer system 110A can inter-mix commands (delimited by predefined command character 350, such as “*”) with standard chat text. However, the users on user computer systems 110B-110n can input standard chat text, but cannot issue commands to target computer system 152A. In this manner, all users can view chat text, issued commands, and responses to commands issued in a chat window as further described herein with reference to FIG. 11.

FIG. 11 illustrates an example of a view of a shared chat window 1100 generated by synchronous collaborative shell-integrated IM system 100 and displayed on user computer systems 110A-110n participating in session 160 in accordance with one embodiment of the invention. As illustrated in FIG. 11, in one embodiment, the first user, e.g., “KRISjr”, is authorized to issue commands to target computer system 152A, but the second user, e.g., “XIN”, and the third user, e.g., “MIKE”, are not.

The first user, e.g., “KRISjr”, can input chat text and commands and view responses to the issued commands, while the second user, e.g., “XIN”, and the third user, e.g., “MIKE”, can input and view chat text and view the commands issued by the first user, e.g., “KRISjr”, and the responses to the commands in chat window 1100. In one embodiment, when all participants in the chat have closed their chat windows, session 160 is terminated by IM server computer system 140 and all sockets are closed.

The embodiments described with reference to FIGS. 6-8 and 10-11 are described with reference to a user on user computer system 110A issuing commands to a single target computer systems 152A, however, in other embodiments, multiple users on user computer systems 10A-10n can issue commands to multiple target computer systems 152A-152n, in accordance with the user's credentials, e.g., the user's authority.

The following program code is an example of pseudo-code that can be used to write a basic collaborative shell program 150 in accordance with one embodiment of the invention. The following pseudo-code is written to be mostly compatible with the JAVA programming language (available from Sun Microsystems, Inc, Santa Clara, Calif.).

The following pseudo-code shows one possible way that the invention can be implemented. For simplicity, the code focuses primarily on the connection and broadcast of messages to a single server (command line actions) and multiple clients. Further, for simplicity, the target computer system, for example, a server, being collaborated around, is hard-coded to be the same target computer system as the IM server computer system, for example, IM server computer system 140. Those of skill in the art can set a parameter to allow users to specify a different target computer system upon connection.

In one embodiment:
/**
*
**/
import java.io.*;
import java.net.*;
public class Client extends Thread {
private Thread thrThis; // client thread
private Socket socket; // socket for connection
private String ip; // the ip of this client
protected BufferedReader in; // captures incoming
messages
protected PrintWriter out; // sends outgoing messages
/**
* Constructor for the Client. Initializes the Client
properties and opens
* a socket for reading and writing.
*
* @param server The server to which this client is
connected.
* @param socket The socket through which this client
has connected.
*/
public Client(String ip, string port) {
this.ip = ip;
this.port = (Integer.decode(port)).intValue( );
// connect to the server
try {
socket = new Socket(ip, port);
} catch (UnknownHostException uhe) {
writeActivity(“Unknown Host Exception: ” +
uhe.getMessage( ));
} catch (IOException ioe) {
writeActivity(“IO Exception: ” + ioe.getMessage( ));
}
// --- init the reader and writer
try {
in = new BufferedReader(new
InputStreamReader(socket.getInputStream( )));
out = new PrintWriter (socket.getOutputStream( ), true);
} catch (IOException ioe) {
system.out,println(“Client IP: ” + ip + “ could not be
”
+ “initialized and has been disconnected.”);
killClient( );
}
}.4
/**
* Thread run method. Posts and handles messages to send
to server.
*/
public void run( ) {
try {
char charBuffer[ ] = new char[1];
// --- while we have an incoming stream
while(in.read(charBuffer,0,1) != −1) {
// --- create a string buffer to hold the incoming
stream
StringBuffer stringBuffer = new StringBuffer(8192);
// --- while the stream hasn't ended
while(charBuffer[0] != ‘\0’) {
// --- add the character to our buffer
stringBuffer.append(charBuffer[0]);
in.read(charBuffer, 0 ,1);
}
// send the message to the output stream of the buffer
out.write(stringBuffer);
}
} catch(IOException ioe) {
system.out.println(“Client IP: ” + ip + “ caused a read
error ”
+ ioe + “ : ” + ioe.getMessage( ) + “and has been
disconnected.”);
} finally {
killClient( );
}
}
/**
* Gets the ip of this client.
* @return ip this client's ip
*/
public String getIP( ) {
return ip;
}
/**
* Sends a message to this client. Called by the
server's broadcast method.
* @param message The message to send.
*/
public void send(String message) {
// --- put the message into the buffer
out.print(message);
// --- flush the buffer and check for errors
// --- if error then kill this client
if(out.checkError( )) {
system.out.println(“Client IP: ” + ip + “ caused a
write error ”
+ “and has been disconnected.”);
killClient( );
}.5
}
/**
* Kills this client.
*/
private void killClient( ) {
// --- tell the server to remove the client from the
client list
server.removeClient(this);
// --- close open connections and references
try {
in.close( );
out.close( );
socket.close( );
thrThis = null;
} catch (IOException ioe) {
system.out.println(“Client IP: ” + ip + “ caused an
error ”
+ “while disconnecting.”);
}
}
public static void main (String args [ ]) {
// --- if correct number of arguments
if (args.length = = 2) {
Client myClient = new Client(args[0], args[1]);
} else {
// otherwise give correct usage
System.out.println(“Usage: java Client [ip] [port]”);
}
}
}
// -----------------------------------------------------
---------------------------------
import java.awt.event.*;
import java.util.*;
import java.awt.*;
import java.io.*;
import java.net.*;
/**
*
* IMServer
* <BR><BR>
* XML socket server that sits on a server machine. It
accepts incoming requests and
* broadcasts output to one or more users. The IMServer
can connect to and relay commands
* to server command line as well.
*
* Usage: java IMServer [port]
*
*/
public class IMServer extends Thread{
private Vector clients = new Vector( ); // a list of all
connected clients
ServerSocket server; // the server.6
String serverIP = “mor.sun.com”; // the server to issue
command to
collaboratively
protected BufferedReader in; // captures incoming
messages
protected PrintWriter out; // sends outgoing messages
Shell shell; // a shell to send commands to
/**
* Constructor for the IMServer. Begins the start server
process.
* @param port Port number the server should listen to
for connections.
*/
public IMServer(int port) {
// start the server
startServer(port);
// open connection to server machine for shell commands
openShell( );
}
/**
* Starts the server and listens for connections.
* @param port Port number the server should listen to
for connections.
*/
private void startServer(int port) {
try {
// create a new server
server = new ServerSocket(port) ;
try {
in = new BufferedReader(new
InputStreamReader(server.socket.getInputStream( )));
out = new PrintWriter(server.socket.getOutputStream( ),
true);
} catch(IOException ioe) {
system.out,println(“could not open buffers”);
}
// while the server is running listen for and handle
new connections
while(true) {
// listen for new client connections
Socket socket = server.accept( );
Client client = new Client (this, socket);
// add the new client to our client list
clients.addElement(client);
// start the client thread for sending/receiving
messages
client.start( );
}
} catch(IOException ioe) {
system.out.println(“could not initialize server”);
// kill this server
killServer( );
}
}.7
void setServerIP (String serverIP) {
this.serverIP = serverIP;
}
public void run( ) {
try {
char charBuffer[ ] = new char[1];
// --- while we have an incoming stream
while(in.read(charBuffer,0,1) != −1) {
// --- create a string buffer to hold the incoming
stream
StringBuffer stringBuffer = new StringBuffer(8192);
// --- while the stream hasn't ended
while (charBuffer[0] != ‘\0’) {
// --- add the character to our buffer
stringBuffer.append(charBuffer[0]);
in.read(charBuffer, 0 ,1);
}
// send the message to the output stream of the buffer
broadcastMessage(stringBuffer.toString( ));
}
} catch(IOException ioe) {
system.out.println(“Server caused a read error ”
+ ioe + “ : ” + ioe.getMessage( )”);
} finally {
killServer( );
}
}
/**
* Broadcasts a message to all connected clients.
Messages are terminated
* with a null character.
* @param message The message to broadcast.
*/
public synchronized void broadcastMessage(String
message) {
// Get the first character
String firstChar = message.substring(0,1);
// if the first character is a ‘*’ send the command to
the server otherwise
// broadcast it as text
if (firstChar = =“*”) {
sendCommand(message.substring(1,message.length( ));
} else {
sendMessage (message);
}
}
private void sendCommand (String command) {
// issue the command to the shell
output = shell.issueCommand(command);.8
// relay the output to all the clients
sendMessage(output);
}
private void sendMessage(String message) {
message += ‘\0’;
// enumerate through the clients and send each the
message
Enumeration enum = clients.elements( );
while (enum.hasMoreElements( )) {
Client client = (Client)enum.nextElement( );
client.send(message);
}
}
private void openShell( ) {
// open a connection to a shell
this.shell = new Shell(serverIP);
}
/**
* Removes clients from the client list.
* @param client The CSClient to remove.
*/
public void removeClient (CSClient client) {
// remove the client from the list
clients.removeElement(client);
}
/**
* Stops the server.
*/
private void killServer( ) {
try {
server.close( );
} catch (IOException ioe) {
writeActivity(“Error while stopping Server”);
}
}
public static void main(String args[ ]) {
// --- if correct number of arguments
if (args.length = = 1) {
IMServer myServer = new
IMServer (Integer.parseInt (args [0]));
} else {
// otherwise give correct usage
System.out.println(“Usage: java IMServer [port]”);
}
}
}.9
// -----------------------------------------------------
---------------------------------
/**
* This is pseudo code for the class shell. The main
purpose for this class is to
* open a connection to a server (via telnet or file
system calls) and issue commands.
* The shell waits for the output and returns it as a
string.
**/
Class Shell {
public Shell (String address) {
//verify that the machine can be reached
// log into the machine and open a connection for
issuing commands
// create a buffer to capture the output of an issued
command
}
String issueCommand (String command) {
// send the command to the server
// wait for the output
// return the output as a String
}
}

As described above, and unlike the prior art, in accordance with the invention, a collaborative shell program links the command line interface (CLI) of an existing CLI shell program to the instant messaging/chat capabilities (herein also termed functionalities) of an existing instant messaging (IM) system. The invention permits one or more users at one or more different user computer systems to issue commands to one or more different target computer systems through a chat window displayed by an IM client application on a user computer system by preceding commands with a predefined command character. Where multiple users are involved, the invention permits collaborative intermixing of text and commands in the chat window.

In one embodiment, the collaborative shell program intercepts incoming text to the IM system from an IM client application and determines whether or not a command is included in the text. In one embodiment, if the first character in the text is not a predefined command character, the text is passed to an IM server application for standard processing. Alternatively, if the first character of the text is a predefined command character, the remaining characters, e.g., the command, is sent to the one or more different target computer systems. In one embodiment, responses to the command are automatically relayed back to the IM client application for display in the chat window.

The invention also provides lightweight status awareness and monitoring of other target computer systems, scripts, bots, agents and/or other persona through the use of buddy lists, collaborative chat windows, and cross platform push notification of alerts.

In one embodiment, the invention permits text messages to be relayed using a single IM protocol to desktop applications, browsers, pagers, cell phones, personal digital assistants (PDAs), and other devices that receive text messaging.

In one embodiment, collaborative shell program 150 can be configured as a computer program product. Herein a computer program product comprises a medium configured to store or transport computer-readable instructions, such as program code for collaborative shell program 150, including all, any, or parts of processes described herein with reference to FIGS. 1-11, or in which computer-readable instructions for collaborative shell program 150, including all, any, or parts of processes described herein with reference to FIGS. 1-11, are stored. Some examples of computer program products are CD-ROM discs, ROM cards, floppy discs, magnetic tapes, computer hard drives, servers on a network and signals transmitted over a network representing computer-readable instructions. Further herein, a means for performing a particular function is accomplished using the appropriate computer-readable instructions and the related hardware necessary to performing the function.

In some embodiments, the presence of a user is not required, allowing the use of the present invention with automated initiation processes. For example, in one embodiment, a user computer system is pre-programmed or pre-set to automatically initiate sessions with IM server computer system 140 and to send commands directed at selected target computer systems.

The foregoing description of implementations of the invention have been presented for purposes of illustration and description only, and, therefore, are not exhaustive and do not limit the invention to the precise forms disclosed. Modifications and variations are possible in light of the above teachings or can be acquired from practicing the invention. Consequently, Applicant does not wish to be limited to the specific embodiments shown for illustrative purposes.

1. A system comprising:
a network;
an instant messaging (IM) server computer system coupled to the network, the IM server computer system comprising:
a collaborative shell program, and
an instant messaging (IM) server application coupled with the collaborative shell program;
at least one user computer system coupled to the network, the at least one user computer system comprising:
an instant messaging (IM) client application, and
a command line interface (CLI) shell program; and
at least one target computer system coupled to the network.

2. The system of claim 1, wherein the at least one user computer system further comprises:
a processor;
an operating system;
an input device; and
a display.

3. A method comprising:
receiving text from a user computer system over a network;
determining whether the text includes a command; and
wherein upon a determination the text includes a command, sending the command to at least one target computer system, and
wherein upon a determination that the text does not include a command, sending the text to an instant messaging (IM) server application.

4. The method of claim 3, further comprising:
receiving a response from the at least one target computer system; and
automatically sending the response to the user computer system.

5. A method comprising:
receiving text over a network from a user computer system, the text including one or more characters;
intercepting the text by a collaborative shell program;
determining whether a first character of the text is a predefined command character; and
upon a determination that the first character of the text is the predefined command character, sending the subsequent characters over the network to at least one target computer system.

6. The method of claim 5, further comprising:
wherein upon a determination that the first character of the text is not the predefined command character, sending the text to an instant messaging (IM) server application.

7. The method of claim 5, further comprising:
receiving a response from the at least one target computer system over the network; and
automatically sending the response over the network to the user computer system.

8. The method of claim 5, wherein the predefined command character is a character not assigned a functionality by a command line interface (CLI) shell program utilized by the user computer system.

9. The method of claim 5, wherein the predefined command character is an asterisk.

10. The method of claim 5, wherein the subsequent characters are a command.

11. The method of claim 7, wherein the response is sent as an instant message.

12. The method of claim 5, further comprising:
receiving a selection of the at least one target computer system from the user computer system over the network.

13. The method of claim 12, wherein the selection of the at least one target computer system is input on a first graphical user interface displayed on the user computer system.

14. The method of claim 13, wherein the first graphical user interface is a buddy list.

15. The method of claim 13, wherein the first graphical user interface is displayed by an instant messaging (IM) client application on the user computer system.

16. The method of claim 5, wherein the text is input to a second graphical user interface displayed on the user computer system.

17. The method of claim 16, wherein the second graphical user interface is a chat window.

18. The method of claim 16, wherein the second graphical user interface is displayed by an instant messaging (IM) client application on the user computer system.

19. A method comprising:
establishing a session connecting one or more user computer systems and one or more target computer systems;
receiving text from at least one of the one or more user computer systems;
determining whether the text includes a command; and
upon a determination that the text includes the command, sending the command to at least one of the one or more target computer systems in the session.

20. The method of claim 19, further comprising:
receiving a response over the network returned from the one or more target computer systems; and
automatically sending the response over the network to the one or more user computer systems in the session.

21. The method of claim 19, wherein the determining whether the text includes a command comprises:
intercepting the text by a collaborative shell program;
determining whether a first character of the text is a predefined command character; and
upon a determination that the first character of the text is the predefined command character, determining the text includes a command.

22. A graphical user interface comprising:
at least one selectable identifier of a target computer system coupled to a network.

23. The graphical user interface of claim 22, further comprising:
a status indicator associated with the at least one selectable identifier of a target computer system coupled to a network.

24. The graphical user interface of claim 22, further comprising:
at least one selectable identifier of a program selected from the group consisting of a script, a bot, and an agent.

25. The graphical user interface of claim 22, further comprising:
at least one selectable identifier of a user having access to the network.

26. A graphical user interface comprising:
at least one selectable identifier of a program selected from the group consisting of a script, a bot, and an agent.

27. The graphical user interface of claim 26, further comprising:
a status indicator associated with the at least one selectable identifier of a program selected from the group consisting of a script, a bot, and an agent.

28. The graphical user interface of claim 26, further comprising:
at least one selectable identifier of a user having access to a network.

29. The graphical user interface of claim 26, further comprising:
at least one selectable identifier of a target computer system coupled to the network.

30. A method comprising:
receiving an event at an instant messaging (IM) server computer system on a network to open a session connection to an instant messaging (IM) client application on at least a first user computer system on the network;
opening a session connection to the IM client application on the at least a first user computer system;
starting a session;
receiving an event to open one or more additional connections within the session to one or more target computer systems on the network;
opening the one or more additional connections to each of the one or more target computer systems;
receiving text input from the at least a first user computer system and the one or more target computer systems;
intercepting the text at the IM server computer system by a collaborative shell program, wherein the text includes one or more characters;
determining whether the text includes a predefined command character;
upon a determination that the text includes the predefined command character, sending the remaining characters to the one or more target computer systems; and
upon a determination that the first character of the text is not the predefined command character, sending the text to an IM server application utilized by the IM server computer system.

31. The method of claim 30, further comprising:
authenticating that a user of the at least a first user computer system has access rights to the one or more target computer systems on the network.

32. The method of claim 30, further comprising:
receiving a response returned from the one or more target computer systems at the IM server computer system; and
automatically sending the response from the one or more target computer systems to the at least one user computer system.

33. A system comprising:
a network;
one or more target computer systems coupled to the network;
one or more user computer systems coupled to the network, each of the one or more user computer systems comprising:
an operating system,
a command line interface (CLI) shell program, the CLI shell program including a command line interface (CLI), and
an instant messaging (IM) client application; and
an instant messaging (IM) server computer system coupled to the network, the IM server computer system comprising:
an instant messaging (IM) server application, the IM server application including IM functionalities, and
a means for linking the command line interface (CLI) of the CLI shell program with the instant messaging (IM) functionalities of the IM server application.

34. The system of claim 33, wherein the IM functionalities of the IM server application comprise:
instant messaging functionalities; and
chat functionalities.

35. The system of claim 33, wherein the means for linking the command line interface of the CLI shell program with the IM functionalities of the IM server application comprises:
means for authenticating each of the one or more users on the one or more user computer systems to each of the one or more target computer systems over the network.

36. A method for monitoring status information over a network comprising:
periodically querying one or more target computer systems on a network for status information;
receiving the status information returned from the one or more target computer systems; and
providing a user at a user computer system on the network with an indication of the status of the one or more target computer systems in a graphical user interface displayed on the user computer system by an instant messaging (IM) client application.

37. The method of claim 36, wherein the indication of the status of the one or more target computer systems is provided by a status indicator displayed in the graphical user interface and associated with each of the one or more target computer systems.

38. A method for monitoring status information over a network comprising:
periodically querying at least one program selected from the group consisting of a script, a bot, and an agent for status information;
receiving the status information returned from the at least one program; and
providing a user at a user computer system on the network with an indication of the status of the at least one program in a graphical user interface displayed on the user computer system by an instant messaging (IM) client application.

39. The method of claim 38, wherein the indication of the status of the at least one program is provided by a status indicator displayed in the graphical user interface and associated with the at least one program.
